(19) United States
(12) Patent Application Publication
(10) Pub. No.: US 2008/0216679 A1
(43) Pub. Date: Sep. 11, 2008

(54) Variable leverage embossing seal

(75) Inventors: Anthony D. MacNeil, Piscataway, NJ (US); Louis D'Amaro, Medfield, MA (US); Thomas Malinowski, Brielle, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: M&R Marking Systems, LLC, Piscataway, NJ (US)

(21) Appl. No.: 11/716,657

(22) Filed: Mar. 9, 2007

(51) Int. Cl. B31F 1/07

(52) U.S. Cl. 101/31.1

(57) ABSTRACT

An embossing seal includes a support frame having an opening at a first end thereof and a die assembly disposed in the opening of the support frame. The embossing seal includes a handle pivotally connected to the frame for moving between an extended position and a compressed position for closing the die assembly, a first link having a trailing end pivotally connected to the frame and a leading end coupled with the die assembly, and a second link having a first end pivotally connected with the handle and a second end pivotally connected with the first link. In operation, when the handle is moved from the extended position to the compressed position, the first and second links close the die. The arrangement of the first and second links provides increased leverage on the die assembly during the later stages of the compression stroke of the handle.

### CROSS-REFERENCE

The present application is related to commonly assigned United States Patent Application Publication No. 2006/0236879, the disclosure of which is hereby incorporated by reference herein.

### FIELD OF THE INVENTION

The present invention relates to embossing seals and more particularly relates to embossing seals having structure that provides greater leverage during an embossing operation.

### BACKGROUND OF THE INVENTION

For many years, seals have been placed on documents to verify their authenticity. One of the earliest seals was created by placing wax on a document and then pressing the face of a ring into the wax. When the document was later presented to a third party, the authenticity of the document was verified by analyzing the image or symbol formed in the wax. Today, seals are created using a press-like device that stamps an image onto a document. Such seals are generally found on government documents such as birth certificates, death certificates and marriage licenses, as well as other documents such as architectural drawings and notarized documents.

Most conventional embossing seals have a die and an opposing counter that move toward one another for forming an image on an article. On the die, the image is depressed from a generally planar surface. The counter also has an image, which mirrors the image that is on the stamping die. The die and the counter can be made using a variety of methods that are well known to those skilled in the art. Typically the die and counter are arranged so that the image created on the document can be read from left to right. In the alternative, the image can be produced so that it can be read from left to right from the debossed side of the document.

In order to place a seal on a document, the item is placed between the die and the counter. The die and counter are then moved toward one another until the opposing elements are separated by only the thickness of the document. Further movement of the die and the counter toward one another results in the raised image on the counter forcing a portion of the article into the depressed image on the die. At maximum pressure, the raised image on the counter and the depressed image on the die are fully engaged with the article for selectively stretching and depressing the image onto the article. If the pressure applied is sufficient to cause the material of the article to stretch or yield, a permanent, precisely formed, raised image will result on one side of the article. The opposite side of the article will have a debossed mirror image of the raised image.

An embossed or debossed image can be formed on almost any type of flexible, deformable material. At one end of the spectrum, the deformable material may be made of metal such as a malleable metal sheet or a metal block. At the other end of the spectrum, the deformable material may be gossamer-like paper. As noted above, the most common articles to be embossed include commercial paper stock used for legal documents, architectural or engineering drawings, government documents, letterhead, envelopes and the like.

There are generally two types of embossing seals: desk seals and pocket seals. Desk seals are typically large, ornate devices that are designed to both impress the observer and to effectively impress a seal onto a document. Size and portability are not major concerns with desk seals. As a result, mechanical features such as levers can be added to a desk seal to make the stamping procedure easier for an operator, without concern for the overall size or weight of the device.

For example, U.S. Patent Application Publication No. 2006/0236879 discloses a spring-assisted embossing seal. In one embodiment, the embossing seal includes a frame, a die exposed at an underside of the frame, and a handle connected to the frame, the handle being movable between an extended position and a depressed position. The embossing seal includes an impact element movable from a first position in contact with the die to a second position spaced from the die, and a spring coupled with the impact element for normally urging the impact element into the first position, the spring being deflectable for storing energy. The embossing seal also has a lever linking the handle to the impact element. In operation, movement of the handle from the extended position toward the depressed position causes the lever to move the impact element from the first position to the second position for deflecting and storing energy in the spring. Further movement of the handle toward the depressed position causes the lever to release the impact element so that the energy stored in the deflected spring is transferred to the impact element for moving the impact element back to the first position so that the impact element strikes the die with a striking force.

Many embossing seals include linkages for obtaining leverage, including U.S. Pat. No. 3,033,106. Other embossing seals include camming surfaces for gaining leverage including U.S. Pat. Nos. 6,938,542, 5,819,647, 5,787,802, 3,554,122, 1,646,612, and 1,434,598.

In spite of the above advances, there remains a need for an embossing seal that is easy to operate and that reduces the level of manual force required to produce a suitable raised image. There is also a need for an embossing seal that is both economical and reliable.

### SUMMARY OF THE INVENTION

The present invention is generally directed to a seal press including a frame or body having a lower portion with a die holder assembly and an upper portion having a handle pivotally attached thereto. The seal press includes a first, pivoted link having a leading end that overlies a die and a trailing end that is pivotally attached to the upper portion of the body via a fixed point pivot. The leading end of the first link is coupled with the handle via a double-ended link having an upper end pivotally connected with an underside of the handle and a lower end pivotally connected with the leading end of the first link. The seal press also includes a roller that projects from an underside of the first link, at the leading end of the first link, for engaging a button on a rear side of the die. The roller insures that the leading end of the first link has a smooth ride over the button on the die during an embossing procedure.

The handle is moveable from an idle or extended position, to a partially compressed position and onto a fully-compressed position. In the idle position, the handle is extended and the die is spaced from a counter of the die holder assembly. An item, such as a document, may be placed between the die and the counter for embossing. In a partially compressed position, the free end of the handle is forced downwardly toward the lower portion of the frame or body. Downward pressure on the free end of the handle pivots the upper end of the double-ended link relative to the lower end of the double-ended link, which in turn pivots the leading end of the first link toward the die holder assembly so as to compress the die holder assembly. The cooperation of the first link and the second, double-ended link provide leverage over the die holder assembly when urging the die holder assembly into the embossing position.

When nearing the fully compressed position, further downward force on the free end of the handle compresses the die holder assembly so as to force the die and the counter together for embossing an object. In the fully compressed position, the double-ended link extends in a substantially vertical direction between the fixed pivot point for the handle and the roller on the pivoted link. This linkage configuration requires minimal downward force on the handle to generate the necessary embossing force upon the die holder assembly. Thus, the seal press design of the present invention requires reduced operator effort, compared to a fixed leverage design, to generate necessary embossing forces.

In certain preferred embodiments of the present invention, an embossing seal includes a support frame, a die assembly connected to the frame, and a handle pivotally connected to the frame for moving between an extended position and a compressed position. The embossing seal may also include a first link having a trailing end pivotally connected to the frame and a leading end coupled with the die assembly, and a second link having a first end pivotally connected with the handle and a second end pivotally connected with the first link. The handle is preferably movable from the extended position to the compressed position for closing the die assembly.

The embossing seal may also include a die assembly engaging element attached to the first link for coupling the first link with the die assembly. The die assembly engaging element may be a roller attached to the leading end of the die assembly for gliding over the backside of the die during an embossing operation.

In one or more preferred embodiments, the frame of the embossing seal has a first end, a second end and an opening provided at the first end, whereby the die assembly is disposed in the opening of the frame and the handle is pivotally connected to the first end of the frame. The frame preferably has a first side wall and a second side wall and the first and second links are disposed between the first and second side walls.

The first and second side walls may have a first set of aligned openings extending therethrough and the embossing seal may further comprise a first post connected with the first set of aligned openings, the first post pivotally connecting the trailing end of the first link with the frame. The first and second side walls may also have a second set of aligned openings extending therethrough. A second post may be connected with the second set of aligned openings and the second post may pivotally connect the handle with the frame.

In certain preferred embodiments, the die assembly may include a first arm having a first end connectable with the frame and a second end holding a die, and a second arm having a first end connectable with the frame and a second end holding a counter, whereby the first ends of the first and second arms are attached to one another. The die assembly may also include at least one projection and the frame may include at least one depression for connecting the die assembly to the frame. In other preferred embodiments, the die assembly may include at least one depression and the frame may include at least one projection for connecting the die assembly to the frame.

In another preferred embodiment of the present invention, an embossing seal includes a frame having a first end, a second end and an opening at the first end, a die assembly disposed in the opening of the frame, and a handle pivotally connected to the frame for moving between an extended position and a compressed position for closing the die assembly. The embossing seal may also include a first link having a trailing end pivotally connected with the frame and a leading end coupled with the die assembly, a roller connected to the leading end of the first link for coupling the first link and the die assembly, and a second link having an upper end pivotally connected with the handle and a lower end pivotally connected with the first link. The handle is desirably movable from an extended position to a compressed position so that the first and second links provide a compression force through the roller and onto the die assembly. In one preferred embodiment, the lower end of the second link is pivotally connected to the leading end of the first link.

The frame may have a first side wall and a second side wall, and the first and second links may be disposed between the first and second side walls. A first post may extend between the first and second side walls of the frame for pivotally connecting the trailing end of the first link with the frame. A second post may extend between the first and second side walls for pivotally connecting the handle with the frame.

In certain preferred embodiments, the die assembly includes a first arm having a first end connectable with the frame and a second end engaging a die, and a second arm having a first end connectable with the frame and a second end engaging a counter for the die, whereby the first ends of the first and second arms are attached to one another and the die and the counter are in substantial alignment with one another.

In another preferred embodiment of the present invention, an embossing seal includes a support frame, a die assembly connected to the support frame, and a handle pivotally connected to the frame for moving between an extended position and a compressed position for closing the die assembly. The embossing seal also preferably includes a link having a trailing end pivotally connected with the frame and a leading end coupled with the die assembly, whereby when the handle is moved from the extended position to the compressed position, the link transfers compression forces to the die assembly for closing the die assembly.

The embossing seal may also include a second link having an upper end pivotally connected with the handle and a lower end pivotally connected with the first link, whereby during an embossing operation the first and second links are coupled together for transferring compression forces to the die assembly when the handle is moved from the extended position to the compressed position. A roller may be attached to the leading end of the first link for coupling the first link with the die assembly

The present invention may be used in pocket seals and desk seals. For simplicity, the discussion herein generally refers to the article being embossed as paper. It is understood, however, that the scope of the invention is broadly applicable to any resilient, flexible materials in sheet form. The present invention may also be used to place seals on larger items such as blocks of metal and wood. For these larger items, a base portion of the frame may be rotated to enable the die to be abutted against a surface of the larger object.

A mechanical advantage may be obtained in the present invention through the use of one or more linkages. In one preferred embodiment of the present invention, manual pressure is exerted on the handle of the embossing seal to urge the die and counter elements toward each other. Once the article (e.g. document) is securely pressed between the die and the counter, additional force applied to the handle of the embossing seal results in an increase in leverage through the links to begin the embossing process.

These and other preferred embodiments of the present invention will be described in more detail below.

### BRIEF DESCRIPTION OF THE DRAWINGS

FIG. 1 shows a perspective view of a frame for an embossing seal, in accordance with certain preferred embodiments to the present invention.

FIG. 2A shows a perspective view of a die holder assembly including a die and a counter, in accordance with certain preferred embodiments of the present invention.

FIG. 2B shows another view of the die holder assembly shown in FIG. 2A.

FIG. 3 shows a perspective view of a handle and a link for an embossing seal, in accordance with certain preferred embodiments of the present invention.

FIG. 4 shows a perspective view of an embossing seal, in accordance with certain preferred embodiments of the present invention.

FIG. 5 shows a cross-sectional view of the embossing seal of FIG. 4 taken along line FIG. 5-FIG. 5 thereof.

FIG. 6 shows the embossing seal of FIGS. 4 and 5 with the handle in the partially compressed position.

FIG. 7 shows the embossing seal of FIGS. 4, 5 and 6 with the handle in the fully compressed position.

### DETAILED DESCRIPTION OF PREFERRED EMBODIMENTS

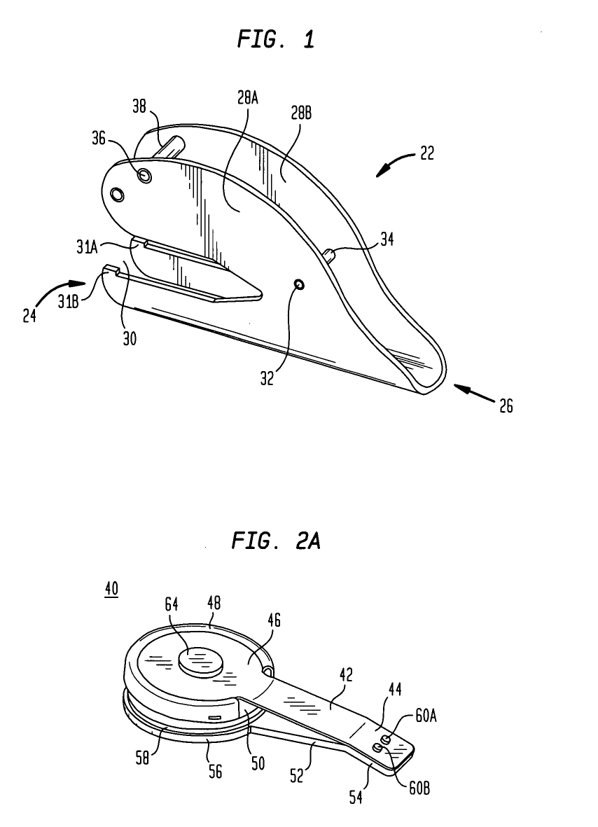

Referring to FIG. 1, in one preferred embodiment of the present invention, an embossing seal includes a frame 22 having leading end 24 and a trailing end 26. In preferred embodiments, the frame 22 is an U-shaped member including a first side wall 28A and a second side wall 28B. The frame includes an opening 30 at the leading end 24 thereof. The side walls 28A, 28B of the frame include aligned openings that enable posts to be positioned therein. As shown in FIG. 1, a first set of aligned openings 32 are adapted to receive a first post 34 and a second set of aligned openings 36 are adapted to receive a second post 38.

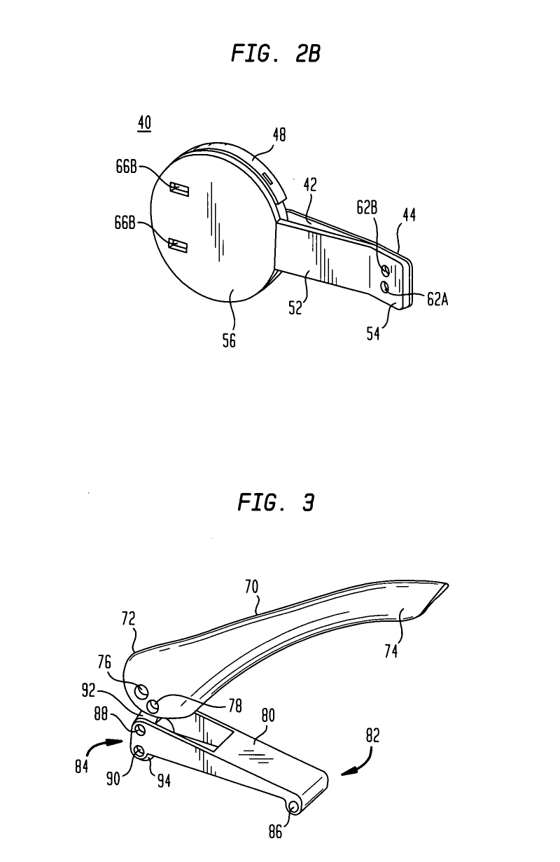

FIGS. 2A and 2B show a die holder assembly 40 including a first arm 42 having a first end 44 and a second end 46. The second end 46 of the arm 42 is preferably coupled with a die holder 48 that is adapted to hold a die 50. The die holder assembly 40 also preferably includes a second arm 52 having a first end 54 and a second end 56 that is adapted to hold a counter 58. When the die 50 and the counter 58 are assembled with the die holder assembly 40, the front face of the die 50 opposes the front face of the counter 58. The respective front faces are preferably aligned with one another and are pressed together to form a seal on an object such as a document. The first and second arms 42, 52 are desirably spring arms that normally hold the die and counter spaced from one another.

Referring to FIG. 2A, the first end 44 of the first arm 42 includes a pair of projections 60A, 60B that are adapted to engage similarly shaped depressions provided on the frame 22 (FIG. 1). Referring to FIG. 2B, the first end 54 of the second arm 52 includes depressions 62A, 62B that are adapted to be received in projections provided on the frame 22 (FIG. 1). The second end 46 of first arm 42 had a button 64 secured thereto. The second end 56 of second arm 52 includes a pair of elongated depressions 66A, 66B that are adapted to be received by elongated notches 31A, 31B at the opening 30 of the frame 22.

Referring to FIG. 3, the embossing seal includes a handle 70 having a leading end 72 and a trailing end 74. The leading end 72 of the handle includes first openings 76 and second aligned openings 78. The embossing seal also includes a first link 80 having a trailing end 82 and a leading end 84. The trailing end 82 includes an opening 86 adapted to receive the post 34 shown in FIG. 1 for pivotally connecting the trailing end 82 of the first link 80 to the frame 22. The first link also includes second aligned openings 88 and third openings 90. The embossing seal also includes a second link 92 that extends between the handle 70 and the first link 80. First link 80 also includes a roller 94 connected with the leading end 84 of the first link 80.

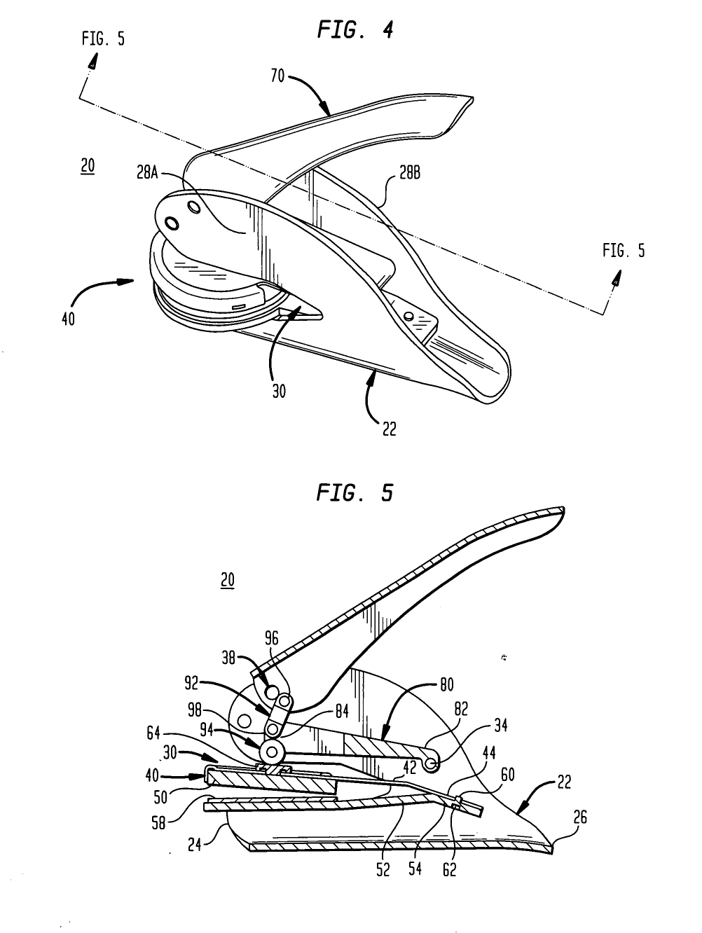

FIG. 4 shows the components of FIGS. 1-3 assembled together the form an embossing seal. The embossing seal 20 includes frame 22 having die holder assembly 40 inserted into the opening 30 at the leading end of the frame. The embossing seal 20 also includes a handle 70 pivotally connected with the frame 22. The first and second links described above extend between the side walls 28A, 28B of the frame 22.

FIG. 5 shows a cross sectional view of the embossing seal shown in FIG. 4, taken along lines FIG. 5-FIG. 5 thereof. The embossing seal 20 includes frame 22 having a leading end 24 and a trailing end 26. The frame includes an opening 30 provided at the leading end 24 thereof. A die holder assembly 40 is inserted into the opening 30 for being connected to the frame 22. The projections 60 at the first end 44 of the first arm 42 are insertable into opposing depressions provided in the frame 22. The depressions 62 provided at the first end 54 of the second arm 52 are coupled with projections on the frame 22. Once the die holder assembly 40 has been connected with the frame 22, the die 50 and counter 58 are positioned adjacent the opening 30 of the frame 22.

The embossing seal 20 also includes the first link 80 having trailing end 82 that is pivotally connected to frame 22 via post 34. The leading end 84 of the first link 80 has a roller 94 connected therewith. The roller 94 preferably projects from the underside of the first link 80 and desirably engages the button 64 provided on a backside of die 50.

The embossing seal 20 also preferably includes second link 92 having an upper end 96 pivotally connected to handle 70 and a lower end 98 pivotally connected to the leading end 84 of first link 80. Thus, the second link 92 is a double-ended link that is pivotally connected to different elements at the ends thereof.

The leading end of the handle 70 is pivotally connected to the frame via post 38 shown in FIG. 1 of the present application. The handle 70 has two pivoting features, the pivot point between the leading end of the handle and the frame 22 and the pivot point between the upper end of the second link 92 and the handle.

FIG. 5 shows the embossing seal in an idle position. The arms 42, 52 of the die holder assembly 40 are preferably spring arms that maintain the opposing faces of the die 50 and counter 58 spaced from one another. In the idle position shown in FIG. 5, the handle 70 is in an extended position and the die 50 and counter 58 are spaced from one another.

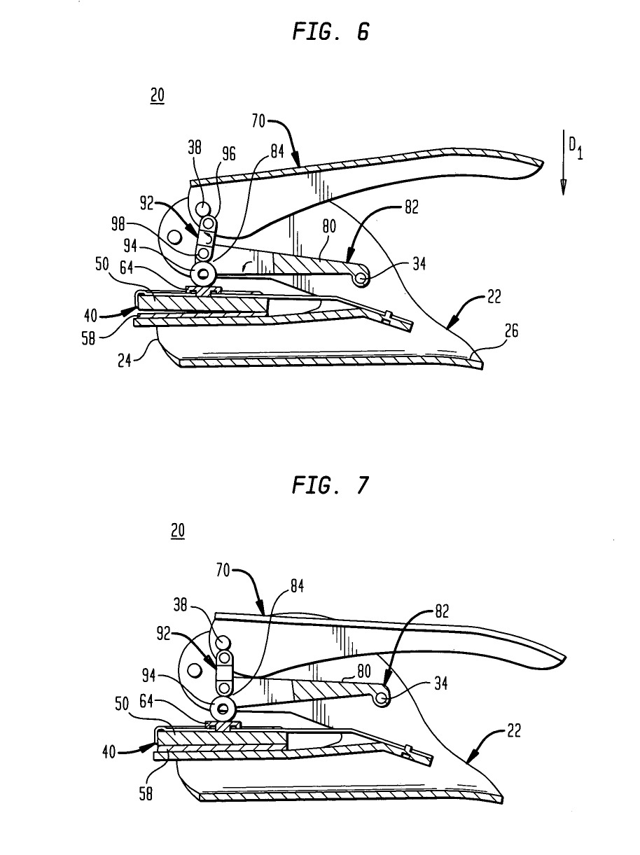

Referring to FIG. 6, as the handle is partially depressed in the direction D1, the die holder assembly 40 is partially compressed so that the die 50 moves toward the counter 58. As the handle 70 pivots about pivot post 38, the upper end 96 of the second link 92 begins to move toward the leading end 24 of the frame 22 relative to the lower end 98 of the second link 92. As a result, when the second link 92 is in the position shown in FIG. 6, it has a more vertical orientation than when the second link is in the position shown in FIG. 5. As the second link 92 assumes the more vertical orientation shown in FIG. 6, the second link 92 applies a downward force on the leading end 84 of first link 80. As a result, the first link pivots downwardly about pivot post 34 so as to apply a downward force onto button 64 through roller 94. The pivoting direction of the second link 92 is shown by the arrow provided on the second link (FIG. 6). The pivoting direction of the first link 80 is shown by the arrow drawn on the first link (FIG. 6).

FIG. 7 shows the embossing seal 20 with the handle 70 in the fully compressed position. When the handle 70 is fully compressed, the second link 92 pivots into an ever more vertical orientation than when in the orientation shown in FIG. 6. As the second link 92 pivots to the orientation shown in FIG. 7, the leading end 84 of the first link 80 is pivoted further in a downward direction about pivot post 34. In FIG. 7, the first link 80 has further rotated about pivot post 34 to assume a more horizontal configuration than the configuration shown in FIG. 6. The roller 94 transfers the compressive force from the first and second links 80, 92 onto the button 64 on the top side of the die holder assembly 40. The roller 94 is able to roll over the upper surface of the button 64 for smoothly gliding over the top of the die holder assembly when transferring compressive forces from the first and second links 80, 92 to the die 50.

Although the present invention is not limited by any particular theory of operation, it is believed that providing a first link 80 having a trailing end 82 pivotally connected to frame 22 and a leading end 84 aligned over a die holder assembly 40, and a double ended second link 94 that is having an upper end pivotally connected to the handle 70 and a lower end pivotally connected to the leading end 84 of the first link 80, a linkage generating variable leverage may be provided for applying variable leverage to the die 50 and counter 58 of a die holder assembly. As a result, in an early stage of an embossing step, the handle moves a great distance while applying minimal compressive force on the die holder assembly. During later stages of the embossing process, however, the first and second links 80, 92 generate increased leverage and compressive force to be applied to the die holder assembly. Thus, the unique linkage shown in the present invention enables an increase in leverage to be generated for forming additional compressive forces during later stages of the compression of the handle 70.

As these and other variations and combinations of the features set forth above can be utilized, the foregoing description of the preferred embodiment should be taken by way of illustration rather than by limitation of the invention.

1. An embossing seal comprising:
a support frame;
a die assembly connected to said frame;
a handle pivotally connected to said frame for moving between an extended position and a compressed position;
a first link having a trailing end pivotally connected to said frame and a leading end coupled with said die assembly;
a second link having a first end pivotally connected with said handle and a second end pivotally connected with said first link, wherein said handle is movable from the extended position to the compressed position for closing said die assembly.

2. The embossing seal as claimed in claim 1, further comprising a die assembly engaging element attached to said first link for coupling said first link with said die assembly.

3. The embossing seal as claimed in claim 2, wherein said die assembly engaging element is a roller attached to the leading end of said die assembly.

4. The embossing seal as claimed in claim 1, wherein said frame has a first end, a second end and an opening provided at the first end, wherein said die assembly is disposed in the opening of said frame and said handle is pivotally connected to the first end of said frame.

5. The embossing seal as claimed in claim 4, wherein said frame has a first side wall and a second side wall and said first and second links are disposed between said first and second side walls.

6. The embossing seal as claimed in claim 5, wherein said first and second side walls have a first set of aligned openings extending therethrough and said embossing seal further comprises a first post connected with said first set of aligned openings, said first post pivotally connecting the trailing end of said first link with said frame.

7. The embossing seal as claimed in claim 6, wherein said first and second side walls have a second set of aligned openings extending therethrough and said embossing seal further comprises a second post connected with the second set of aligned openings, said second post pivotally connecting said handle with said frame.

8. The embossing seal as claimed in claim 1, wherein said die assembly comprises:
a first arm having a first end connectable with said frame and a second end holding a die;
a second arm having a first end connectable with said frame and a second end holding a counter, wherein the first ends of said first and second arms are attached to one another.

9. The embossing seal as claimed in claim 1, wherein said die assembly includes at least one projection and said frame includes at least one depression for connecting said die assembly to said frame.

10. The embossing seal as claimed in claim 1, wherein said die assembly includes at least one depression and said frame includes at least one projection for connecting said die assembly to said frame.

11. An embossing seal comprising:
a frame having a first end, a second end and an opening at the first end;
a die assembly disposed in the opening of said frame;
a handle pivotally connected to said frame for moving between an extended position and a compressed position for closing said die assembly;
a first link having a trailing end pivotally connected with said frame and a leading end coupled with said die assembly;
a roller connected to the leading end of said first link for coupling said first link and said die assembly;
a second link having an upper end pivotally connected with said handle and a lower end pivotally connected with said first link, wherein said handle is movable from an extended position to a compressed position so that said first and second links provide a compression force through said roller and onto said die assembly.

12. The embossing seal as claimed in claim 11, wherein the lower end of said second link is pivotally connected to the leading end of said first link.

13. The embossing seal as claimed in claim 11, wherein said die assembly comprises a first arm holding a die and a second arm holding a counter, said first and second arms having first ends that are attached to one another.

14. The embossing seal as claimed in claim 11, wherein said frame has a first side wall and a second side wall and said first and second links are disposed between said first and second side walls.

15. The embossing seal as claimed in claim 14, further comprising a first post extending between said first and second side walls of said frame for pivotally connecting the trailing end of said first link with said frame.

16. The embossing seal as claimed in claim 15, further comprising a second post extending between said first and second side walls for pivotally connecting said handle with said frame.

17. The embossing seal as claimed in claim 11, wherein said die assembly comprises:
a first arm having a first end connectable with said frame and a second end engaging a die;
a second arm having a first end connectable with said frame and a second end engaging a counter for said die, wherein the first ends of said first and second arms are attached to one another and said die and said counter are in substantial alignment with one another.

18. An embossing seal comprising:
a support frame;
a die assembly connected to said support frame;
a handle pivotally connected to said frame for moving between an extended position and a compressed position for closing said die assembly;
a link having a trailing end pivotally connected with said frame and a leading end coupled with said die assembly, wherein when said handle is moved from the extended position to the compressed position said link transfers compression forces to said die assembly for closing said die assembly.

19. The embossing seal as claimed in claim 18, further comprising a second link having an upper end pivotally connected with said handle and a lower end pivotally connected with said first link, wherein during an embossing operation said first and second links are coupled together for transferring compression forces to said die assembly when said handle is moved from the extended position to the compressed position.

20. The embossing seal as claimed in claim 19, further comprising a roller attached to the leading end of said first link for coupling said first link with said die assembly.
